(19) United States
(12) Patent Application Publication
(10) Pub. No.: US 2010/0053167 A1
(43) Pub. Date: Mar. 4, 2010

(54) STATISTICAL ECONOMIC DATA DISPLAY SYSTEM AND PROGRAM

(76) Inventors: Noboru Shinohara, Tokyo (JP); Naohito Doi, Tokyo (JP); Takeshi Yamamoto, Tokyo (JP); Miki Inomata, Tokyo (JP)

Correspondence Address: STAAS & HALSEY LLP, SUITE 700, 1201 NEW YORK AVENUE, N.W., WASHINGTON, DC, 20005, US

(21) Appl. No.: 12/516,142

(22) PCT Filed: Nov. 28, 2006
(86) PCT No.: PCT/JP2006/323722

§ 371 Date: May 22, 2009

(51) Int. Cl. G06T 11/20

(52) U.S. Cl. 345/440

(57) ABSTRACT

Even if a display means or a memory capacity of a terminal device is small in size, a plurality of economic statistical data are displayed in such a form that the data can be compared with each other. Out of economic statistical data a client terminal device (1a) acquires from a server (2a) on the basis of one operation command, a character information forming unit (17) makes a display unit (13) display character information first. All the acquired economic statistical data are recorded in a data recording unit (141). When a mouse cursor is set on a graph display icon associated with a specific character, image data that display a graph corresponding to the character information are acquired from the data recording unit (141) and the image data are subjected to a popping-up display on the display unit (13).

### BACKGROUND OF THE INVENTION

1. Technical Field

The present invention relates to a technology for displaying statistical economic data, for example, money market data, stock price data or security exchange data, on a computer interface.

2. Background Art

Statistical economic data corresponding to statistics of Industry, Commerce, Manufacturing Industry and so on are very important for investors, experts at economy or security exchange, etc. and companies of Marketing business, for example, purchase and offer of stock, credit and so on, Mergers and Acquisitions (M&A), investment and financing, when they make their decisions related to investment or offer. Because of this, there are database services for gathering and managing the statistical economic data by using databases, and supplying it to users via Internet or other telecommunication medium. The users of the database services acquire their desired statistical economic data from the database by using a client terminal. The acquired statistical economic data are used and, if necessary, converted to desired graphs or lists by using a spreadsheet program or other computer software. There are many cases where the users of statistical economic data obtain plural kinds of statistical economic data and convert them to plural kinds of graphs for visually comparing them.

However, it is difficult for the users to expect what graph is made before statistical economic data is acquired from the database, because the statistical economic data are composed of time-sequence data (i.e. group of numerical data periodically gathered and/or tallied up) of specific field and title information indicating the field name of the specific field.

As a conventional art (for example, the patent document I described below), there is a system which downloads statistical economic data stored in a database of a server to a client terminal used by an investor and so on, and displays it by using a display device which has a screen part displaying numerical data as a graph and another screen part displaying text information such as news related to the displayed graph. Such system can make and display a graph of the statistical economic data without converting the data using spreadsheet software.

Patent document I: Japanese Publication Number 10-320469

However, the system of the Patent document I cannot display plural kinds of the statistical economic data at the same time, so only one graph can be displayed at one time. Moreover, it is difficult for the users to compare these graphs with each other, because scale (for example, scale of time coordinate) of these graphs are different from each other, even if the plural number of graphs can be displayed at the same time. Furthermore, the individual data and graph are difficult to view, in the case where plural kinds of the statistical economic data, specially, plural kinds of graphs, are displayed on a small screen of a display device of a computer terminal at the same time. In addition, the patent document I described above has a technical disadvantage that frequency of communication increases and the response time from requesting an acquisition of data to actually displaying the data is very long, because the server is accessed every time the contents or the items of the displayed data are changed, in the case where plural number of the statistical economic data are displayed at the same time. In the meantime, the frequency of communication can be reduced by storing all data into the client terminal. However, the client terminal will need the storage medium of large capacity, because data quantities of the statistical economic data become very large. Therefore, the structures of the hardware, which can be used for realizing the client terminal, are restricted.

The purpose of the present invention is to provide a statistical economic data display system which can display plural kinds of statistical economic data in a condition that users can view them easily even if the screen size of display device and/or the capacity of storage device are small, can easily compare the numerical data forming the statistical economic data without using a spreadsheet software, can prevent an increase in the frequency of communication and can decrease a response time when the data are displayed. In other words, the purpose of the present invention is to provide a statistical economic data display system, which can realize high usability.

### SUMMARY OF THE INVENTION

For solving above described problem, the first aspect of the present invention comprises a server storing plural statistical economic data containing text data and numerical data related to the text data, and a client terminal making a display means to visually display the statistical economic data being acquired from the server, wherein: the server comprises; a graph drawing means which draws a graph based on the numerical data, and converts the drawn graph to an image data, a data edit means which generates an edited statistical economic data correlating the graph drawn by the graph drawing means and the text data corresponding to the numerical data used for the drawing of the graph, and converts the edited statistical economic data to a state that can be send to the client terminal: the client terminal comprises; a data acquisition means which acquires a plurality of the edited statistical economic data from the server based on a data acquisition command, a data memory means which stores the edited statistical economic data acquired by the data acquisition means, a text information generation means which makes the display means to display at least a part of the text data of the edited statistical economic data acquired by the data acquisition means, as a visual text information, a graph display means which reads the graph corresponding to the text information from the data memory means, and makes the display means to display the read numerical data as a pop up picture of a visual image information, when a specific text information displayed by the display means or a specific position on the display means related to the text information is pointed by a mouse cursor or other pointing device, and wherein the graph drawing means comprises a scale setting means which acquires the numerical data belonging to a predetermined time period as a candidacy group, and sets the numerical data contained in the candidacy group so that the scale of the graph corresponds to a predetermined time period and so the graph can be compared with a plurality of other graphs.

The second aspect of the present invention comprises a server storing plural statistical economic data containing text data and numerical data related to the text data, and a client terminal making a display means to visually display the statistical economic data being acquired from the server, wherein: the server comprises a data edit means which converts the statistical economic data to a state that can be send to the client terminal: the client terminal comprises; a data acquisition means which acquires a plurality of the statistical economic data from the server based on a data acquisition command, a data memory means which stores the statistical economic data acquired by the data acquisition means, a text information generation means which makes the display means to display at least a part of the text data of the statistical economic data acquired by the data acquisition means, as a visual text information, a graph drawing means which draws a graph based on the numerical data, and converts the drawn graph to an image data, a graph display means which reads the graph corresponding to the text information from the data memory means, and makes the display means to display the read numerical data as a pop up picture of a visual image information, when a specific text information displayed by the display means or a specific position on the display means related to the text information is pointed by a mouse cursor or other pointing device, and wherein the graph drawing means comprises a scale setting means which acquires the numerical data belonging to a predetermined time period as a candidacy group, and sets the numerical data contained in the candidacy group so that the scale of the graph corresponds to a predetermined time period and so the graph can be compared with a plurality of other graphs.

In accordance with the present invention, it is desirable that the scale setting means acquires the numerical data belonging to a time period from the nearest specific timing, as the candidacy group, and sets the acquired candidacy group to the scale of the time period from the nearest specific timing.

In accordance with the present invention, it is desirable that the scale setting means extracts the maximum value and the minimum value of the numerical data extracted from the candidacy group, and sets the scale of vertical axis so that the maximum value and the minimum value of the numerical data are substantially the same as the maximum value and the minimum value of the vertical axis's direction.

In accordance with the present invention, it is desirable that the graph display means displays all graphs so that the position at horizontal direction of the display means are the same.

In accordance with the present invention, it is desirable that the server comprises a command generation means which generates action command to make the data acquisition means, the text information formation means, the graph display means and predetermined compositions of the client terminal to perform predetermined actions.

The third aspect of the present invention comprises a program that makes a computer to work as one of the client terminals and the server of the statistical economic data display system according to one of claims 1 to 6.

### Effects of the Invention

In accordance with the first aspect of the present invention, the server comprises a graph drawing means which draws a graph of the numerical data and forms an image data of the drawn graph, and comprises a data edit means which generates an edited statistical economic data corresponding to the graph drawn by the graph drawing means and the text data being related to a numerical data used for drawing the graph, furthermore, the edited data edit means converts the edited statistical economic data to the data that can be send to the client terminal. Consequently, the client terminal can display the statistical economic data as a graph easy to recognize visually and text data of which a summary are easy to recognize. Moreover, the client terminal comprises a data acquisition means that acquires plural edited statistical economic data from the server, based on one data acquisition command, and comprises a data memory means that stores the edited statistical economic data acquired by the data acquisition means. Consequently, the present invention of the first aspect can suppress the increase of communication frequency and can immediately display the text data and the graph, which have not been displayed yet, without requesting reacquisition of the data to the server. Furthermore the client terminal comprises a text information formation means that makes the display means to display at least a part of the text information contained in the edited statistical economic data acquired by the data acquisition means, as visually text information. Consequently, the present invention of the first aspect can display the statistical economic data under a state easy to view, even if there is large number of data items of the acquired statistical economic data. Additionally, the client terminal comprises a graph display means which reads the graph corresponding to the specific text information from the data memory means and displays the read numerical data on the display means as a pop up picture of the visual image information, when the specific text information displayed on the display means or the specific position on the display means is pointed out by the mouse cursor or other kind of pointing device. Consequently, the present invention of the first aspect can display the graph while keeping the text information displayed, and so the text information and the graph to which the users want to view can be simultaneously displayed on the display means, under a state easy to view. In addition, the graph drawing means of the server comprises a scale setting means, which acquires the numerical data corresponding to a predetermined time period as a candidacy group and sets the scales of the time periods of the numerical data contained in the candidacy group so that plural graphs can be compared with each other, when acquiring plural numerical data contained in plural statistical economic data and formatting plural graphs. Consequently, the present invention of the first aspect can make the scales of time direction of plural graphs displayed on the display means identical with each other, and so the users can compare visually the plural graphs displayed on the display means with each other. As a result, the present invention of the first aspect can display plural statistical economic data so as to be easy to view, even if the screen size of the display means and storage capacity of the memory means of the client terminal are small. Moreover, the present invention of the first aspect can compare the numerical data of the statistical economic data with each other without using the spreadsheet software, can prevent the increase of communication frequency, can shorten the response time to display the necessary data, and can display plural graphs, to which the user want to view, under the state easy to view. Therefore, the present invention of the first aspect can supply high usability.

In accordance with the second aspect of the present invention, the server comprises a data edit means, which edits the statistical economic data to the data that can be send to the client terminal. Consequently, the client terminal can display the statistical economic data. Moreover, the client terminal comprises a data acquisition means that acquires plural statistical economic data based on one data acquisition command from the server, and comprises a data memory means that stores the statistical economic data acquired by the data acquisition means. Consequently, the present invention of the second aspect can suppress the increase of communication frequency and can immediately display the text data and the graph, which have not been displayed yet, without requesting reacquisition of the data to the server. Furthermore, the client terminal comprises a text information formation means that makes the display means to display at least a part of the text information contained in the statistical economic data acquired by the data acquisition means, as visually text information. Consequently, the present invention of the second aspect can generate text data, which is easy to grasp summaries of it, from the statistical economic data, and display the statistical economic data under a state easy to view, even if there is large number of data items of the acquired statistical economic data. Additionally, the client terminal comprises a graph drawing means that draws a graph of the numerical data and forms an image data of the drawn graph. Consequently, the client terminal can display the statistical economic data as the graph easy to recognize visually. Additionally the client terminal comprises a graph display means that reads the graph corresponding to the specific text information from the data memory means and display the read numerical data on the display means as pop up picture of the visual image information, when the specific text information displayed on the display means or the specific position on the display means is pointed out by the mouse cursor or other kind of pointing device. Consequently, the present invention of the second aspect can display the graph while keeping the text information displayed, and so the text information and the graph to which the user want to view can be simultaneously displayed on the display means, under a state easy to view. In addition, the graph drawing means comprises a scale setting means, which acquires the numerical data corresponding to a predetermined time period as a candidacy group and sets the scales of the time periods of the numerical data contained in the candidacy group so that plural graphs can be compared with each other, when acquiring plural numerical data contained in plural statistical economic data and formatting plural graphs. Consequently the present invention of the second aspect can make the scales of time direction of graphs displayed on the display means identical with each other, and the user can compare visually the plural graphs displayed on the display means with each other. As a result, the present invention of the second aspect can display plural statistical economic data so as to easy to view, even if the screen size of the display means and storage capacity of the memory means of the client terminal are small. Moreover, the present invention of the second aspect can compare the numerical data of the statistical economic data with each other without using the spreadsheet software, can prevent the increase of communication frequency, can shorten the response time to display the necessary data, and can display plural graphs, to which the user want to view, under the state easy to view. Therefore, the present invention of the second aspect can supply high usability. Moreover, the present invention of the second aspect allocates the graph drawing means to the side of the client terminal, and so the present invention of the second aspect can form the image data, the process of which needs high load, in the side of the client terminal. Therefore, the present invention of the second aspect can reduce the load of the server.

In the case where the scale setting means of the present invention is constituted to acquire the numerical data corresponding to the predetermined time period from the nearest specific timing as a candidacy group, and sets scales of the time periods of the acquired candidacy group to the predetermined time period from the nearest specific timing, the present invention can generate graphs based on the nearest statistical economic data. Consequently, the present invention can display plural information, usability of which is highest for the user, so as to be able to compare with each other, and so the usability can be more increased.

In the case where the scale setting means of the present invention is constituted to extract the maximum value and the minimum value of the numerical data contained in the candidacy group, and set the scale of vertical axis direction so that the maximum value and the minimum value of the numerical data become equal to the maximum value and the minimum value of the vertical axis of the graphs, the tendency of the variation toward the vertical direction of the graphs becomes clear and so the summaries of the numerical data become easy to be grasped. As a result, the usability can be still more increased.

In the case where the graph display means of the present invention is constituted to display all of the graphs so that the positions toward the horizontal axis are identical with each other, all of the positions of the horizontal coordinate become identical with each other on the display means, and so the time information, which are the information corresponding to the horizontal axis when the graph of the statistical economic data are generated, are unified as the information of the positions on the display means. Therefore, it becomes easy to compare the plural graphs visually, and so the usability can be still more increased.

In the case where the command generation means in the server of the present invention is constituted to output an action command for making the predetermined construction element in the client terminal to perform the predetermined action, the server side can control the predetermined action of the client terminal. Consequently, the user of the client terminal can use the system without inputting the action command for the predetermined action, and so the usability can be still more increased.

In accordance with the third aspect of the present invention, the present invention can be realized on various kinds of computer hardware by realizing the present invention as a program.

### BRIEF DESCRIPTION OF DRAWINGS

FIG. 1 is a diagram showing the system structure and function blocks according to the first preferred embodiment of the statistical economic data display system of the present invention.

FIG. 2 is a conceptual diagram showing the data structure of a sequence of a statistical economic data which is contained in plural sequences of the statistical economic data stored in a database server according to the first preferred embodiment of the statistical economic data display system of the present invention.

FIGS. 3A and 3B are flowcharts showing procedures of acquiring statistical economic data and displaying text information in the first preferred embodiment of the statistical economic data display system of the present invention.

FIG. 4A is a flowchart showing a procedure of displaying a graph in the first preferred embodiment of the statistical economic data display system of the present invention. FIG. 4B is a flowchart showing a procedure of erasing text information from display in the first preferred embodiment of the statistical economic data display system of the present invention.

FIG. 5A is a flowchart showing a procedure of selecting a specific statistical economic data which is desired to acquire in the first preferred embodiment of the statistical economic data display system of the present invention. FIG. 5B is a flowchart showing a procedure of displaying the name of selected statistical economic data on a web browser in the first preferred embodiment of the statistical economic data display system of the present invention. FIG. 5C is a flowchart showing a procedure of downloading the selected statistical economic data to the side of client terminal in the first preferred embodiment of the statistical economic data display system of the present invention.

FIG. 6 is a conceptual diagram showing the display screen for executing a search in the first preferred embodiment of the statistical economic data display system of to the present invention.

FIG. 7 is a conceptual diagram showing the display screen for displaying text information in the first preferred embodiment of the statistical economic data display system of the present invention.

FIG. 8 is a conceptual diagram showing a screen area for displaying a graph in the first preferred embodiment of the statistical economic data display system of the present invention.

FIG. 9 is a conceptual diagram showing a situation of which a graph display area is displayed on a web browser in the first preferred embodiment of the statistical economic data display system of the present invention.

FIG. 10 is a conceptual diagram showing a state of which a graph display area is displayed on a web browser in the first preferred embodiment of the statistical economic data display system of the present invention.

FIG. 11 is a conceptual diagram showing a name table in the first preferred embodiment of the statistical economic data display system of the present invention.

FIG. 12 is a diagram showing the system structure and function blocks according to the second preferred embodiment of the statistical economic data display system of the present invention.

### DESCRIPTION OF THE PREFERRED EMBODIMENT

The embodiments of the present invention are described hereinafter.

### First Embodiment of the Present Invention

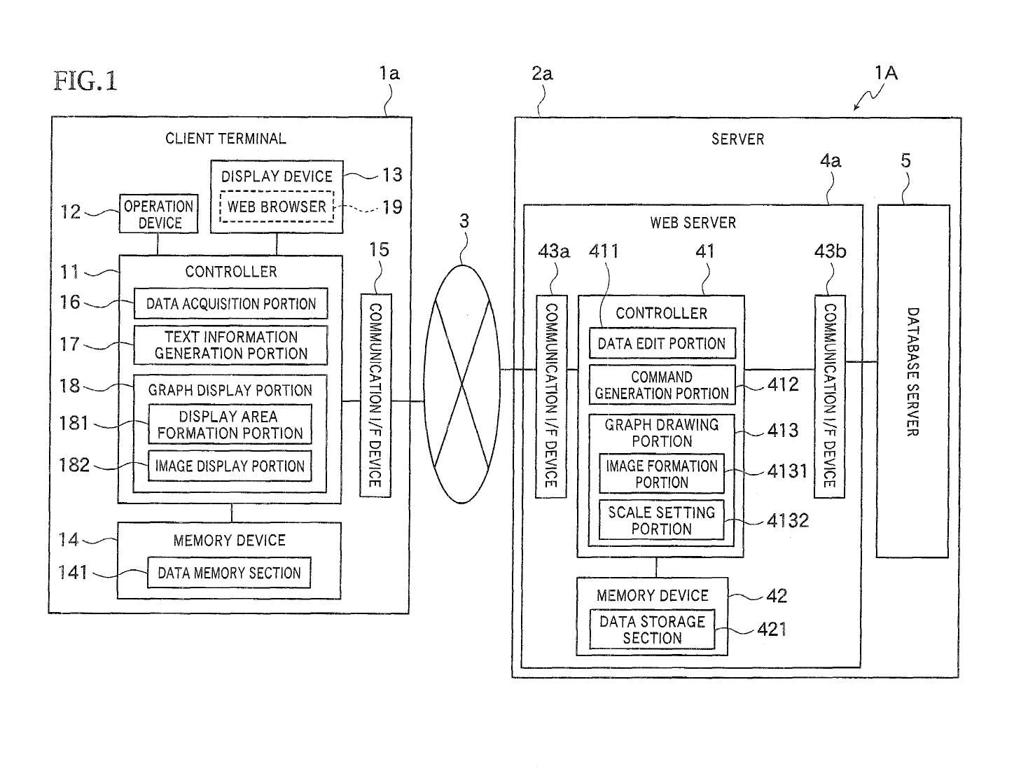

FIG. 1 through FIG. 11 show the first embodiment of the present invention.

FIG. 1 is a diagram showing the system structure and function blocks according to the present embodiment of the statistical economic data display system. As shown in FIG. 1, a client terminal 1a and server 2a of a statistical economic data display system 1A are connected to Internet 3.

The client terminal 1a is a computer that is capable of connecting to a network, for example, personal computer, workstation or mobile telephone terminal and so on. The client terminal 1a comprises a controller 11, an operation device 12, a display device (i.e. display means) 13, a memory device 14 and a communication interface (I/F) device 15.

The controller 11 comprises a CPU (Central Processing Unit). The controller 11 performs computation processing of an OS (Operating System) program, various applications programs and so on, and controls the general processing of the client terminal 1a.

The controller 11 comprises a data acquisition portion (i.e. a data acquisition means) 16, a text information generation portion (i.e. a text information generation means) 17 and graph display portion 18, as functional means. Furthermore, the graph display portion 18 comprises a display area formation portion 181 (i.e. a display area formation means) and an image display portion 182. These functional means are realized by the cooperation of the CPU of the controller 11 and the application programs stored in the memory device 14.

The data acquisition portion 16 acquires statistical economic data from the server 2a based on the data acquisition commands input from the operation device 12. The text information generation portion 17 converts the text data, which is contained in the statistical economic data acquired by the data acquisition portion 16, to text information for displaying, and makes the display device 13 to display the information. The graph display portion 18 makes the display device 13 to display the image data corresponding to the graphs contained in the statistical economic data acquired by the data acquisition portion 16. Incidentally, the graph display portion 18 acquires numerical data 51b from a data memory section 141 formed in the memory device 14.

The display area formation portion 181 sets up a graph display screen area for displaying a graph, and makes the display device 13 to display the graph. The display area formation portion 181 has a function for deciding a position of screen area on which the graphs are displayed based on predetermined condition. Moreover, the display area formation portion 181 has a dynamic generation function for making the display device 13 to display the image of the graph display screen area, which is set up by the display area formation portion 181, by using a pop up picture. The dynamic generation function of the present embodiment is realized based on programs being described by using JavaScript (registered trademark), for example. As a result, a pop up picture on a web browser is realized without depending on the machine type of the client terminal 1a.

The image display portion 182 makes the display device 13 to display image data generated in the web server 4a, as described below. These image data are made for displaying graphs based on the statistical economic data, as described in detail below.

The operation device 12 is, for example, a mouse, a keyboard and so forth, and is used for inputting various kinds of orders. The display device 13 is, for example, a LCD (Liquid Crystal Display) and so forth. The display device 13 displays various kinds of orders input from the operation device 12 and various kinds of images. The display device 13 displays images of information, which are acquired from the server 2a by using HTTP (Hyper Text Transfer Protocol) communication, to a screen of a web browser 19.

The communication interface 15 is, for example, a UTP (Unshielded Twisted Pair) cable port, an optical fiber cable port or a kind of device driver. The communication interface 15 is connected to a LAN (Local Area Network) cable or an optical fiber cable, and performs processes necessary for the data communication with the server 2a.

The memory device 14 comprises a ROM (Read Only Memory) which stores loading programs and other programs in advance, a RAM (Random Access Memory) which temporarily stores programs and data, and works as a working area of the controller 11 (i.e. CPU), a EEPROM (Electrically Erasable Programmable Read Only Memory) which stores data necessary to be rewritten, a hard disk which stores various kinds of file data and so forth. The hard disk stores an OS program, various kinds of application programs and so forth. The RAM comprises the data memory section 141 (i.e. the data memory means), which stores the statistical economic data being acquired by the data acquisition portion 16 from the server 2a. The RAM can read data from the controller 11 at high speed. Incidentally, the data memory section 141 can be constituted in a hard disk for keeping data in the data memory section 141 permanently.

The server 2a is a family of computers having a function of server. The server 2a comprises a web server 4a and a database server 5. The web server 4a has a controller 41 which is substantially the same as the controller 11 in the client terminal 1a, a memory device 42 which is substantially the same as the memory device 14 in the client terminal 1a, and communication interface devices 43a and 43b which are substantially the same as the communication interface device 15 in the client terminal 1a.

The controller 41 comprises a data edit portion (i.e. a data edit means) 411 and a command generation portion (i.e. a command generation means) 412 and a graph drawing portion (i.e. a graph generation means) 413, each of which is constructed as functional means by using application programs. Furthermore, the graph drawing portion 413 comprises an image formation portion 4131 and a scale setting portion (i.e. a scale setting means) 4132.

The data edit portion 411 has a function for editing data stored in the database server 5 to data of HTML (Hyper Text Markup Language) format, and sending the HTML data to the client terminal 1a. The data edit portion 411 realizes a data communication of statistical economic data using Internet 3.

The command generation portion 412 outputs construction commands for making the client terminal 1a to construct the functional means. The functional means are ‘the predetermined construction elements’ for making the client terminal 1a to work as parts of the statistical economic data display system. The predetermined construction elements are, for example, the data acquisition portion 16, the text information generation portion 17, the graph display portion 18 and so forth. Furthermore, the command generation portion 412 outputs work commands for making ‘the predetermined construction elements’ of the client terminal 1a to perform ‘the predetermined work’ as parts of the statistical economic data display system. Concretely, such construction commands and work commands are sent to the client terminal 1a as HTML documents generated in the web server 4a.

The graph drawing portion 413 has a function for drawing diagrams and generating image data. The graph drawing portion 413 performs scale adjustment of the vertical axis and the horizontal axis by using the numerical data, performs graph drawing process, and performs image data generation process. In the present embodiment, the function for drawing graph is realized by using a graph drawing application, for example ‘JfreeChart’. It is desirable that the image data is generated to have an image format that is easy to send via Internet 3, for example, JPEG (Joint Photograph Experts Group), GIF (Graphics Interchange Format) and so forth.

The image formation portion 4131 draws a graph (for example, a line graph), and formats an image data of the graph to be displayed on a plot area.

The scale setting portion 4132 sets scales of the vertical axis and the horizontal axis of the graph so that the graph is displayed on the plot area in the graph display area at most suitable size when the graph is drawn on the plot area, based on the maximum value, minimum value, the values of time-sequence and so forth.

The memory device 42 comprises a data storage section 421, which is used for temporarily storing the specified statistical economic data based on a request from the client terminal 1a.

The database server 5 stores large quantity of the statistical economic data 51₁, 51₂, . . . , 51ₙ (n is larger than 1). Incidentally, all of the statistical economic data 51₁, 51₂, . . . , 51ₙ have same data structure, and so these data are described as statistical economic data 51 for simple explanation hereinafter, except for the cases in which distinction between these data is necessary.

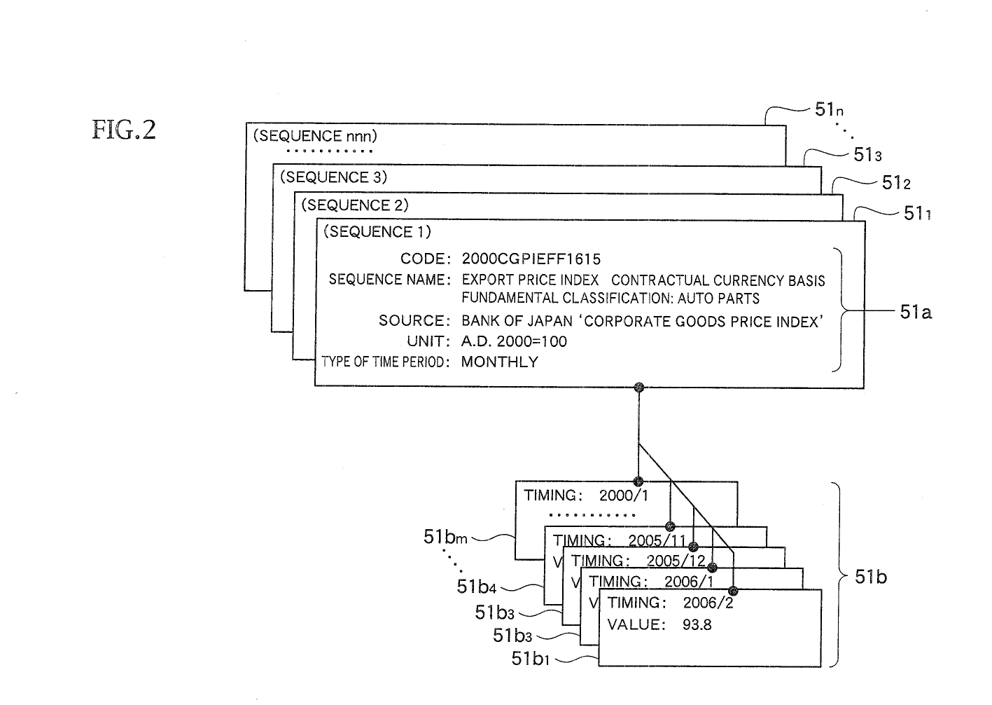

FIG. 2 shows a conceptual diagram of the data structure of a statistical economic data 51, which is stored in a database server 5. As shown in FIG. 2, each of sequence of the statistical economic data 51 (that is, a minimum unit of the statistical economic data 51 in the present embodiment, it is similar as follows) contains one attribution data 51a and plural number of numerical data 51b₁, 51b₂, . . . , 51bₘ (m is larger than 1). Incidentally, all of the numerical data 51b₁, 51b₂, . . . , 51bₘ have same data structure, and so these data are indicated as statistical economic data 51b for simple explanation hereinafter, except for the cases in which distinction between these numerical data is necessary.

The attribution data 51a is a text data indicating a common characteristic of all numerical data 51b₁, 51b₂, . . . , 51bₘ contained in a sequence. The attribution data 51a is used, for example, when the client terminal 1a searches specific sequences, and when numerical data 51b of a specific sequence are displayed as a graph. Concretely, the attribution data 51a contains a ‘code’ described by alphanumeric characters and defined by a sequence, a ‘sequence name’ of the sequence, a ‘source’ that is the original source of numerical data 51b in the concerned sequence, a ‘unit’ that is a specific numerical data 51b used as a standard value when the graph of the numerical data 51b of the concerned sequence is displayed or real value of the specific numerical data 51b, a ‘type of time period’ of the numerical data 51b of the concerned sequence and so forth. Incidentally, the ‘name of sequence’ is a name of field or classification of the statistical economic data, for example, price index, proceeds, stock price and so forth. Moreover, in FIG. 2, the ‘unit’ of the attribution data 51a of the statistical economic data 51₁ indicates that the standard value ‘100’ is the average of the ‘value’ (which is described below) contained in the numerical data 51b, at the ‘timing’ (which is described below) of which is ‘A.D. 2000’. The ‘type of time period’ of FIG. 2 indicates that the ‘value’ of each numerical data 51b is acquired ‘monthly’, that is, ‘by month’.

The numerical data 51b is value information of the statistical economic data 51. The numerical data 51b corresponds to the field being described by ‘name of sequence’, and ‘unit’ of the attribution data 51a. The numerical data 51b contains a ‘timing’ indicating the time when the data is acquired and a ‘value’ indicating the real value of the statistical economic data 51 at the concerned ‘timing’. In FIG. 2, the ‘timing’ of the numerical data 51b₁ is February, A.D. 2000 and ‘value’ of it is 93.8 (that is the relative value when the standard time is A.D. 2000 and the standard value of the standard time is 100).

Incidentally, while FIG. 2 does not show in detail, other sequences of the statistical economic data 51 stored in the database 5 have the same structure as the structure described above (i.e. the structure of the statistical economic data 511 shown in FIG. 2).

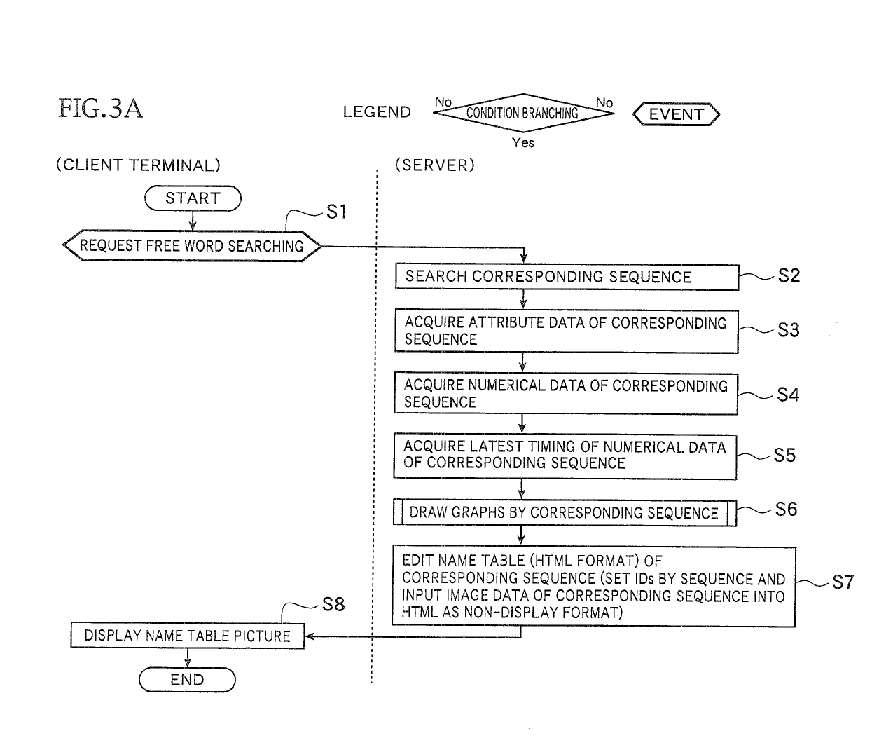

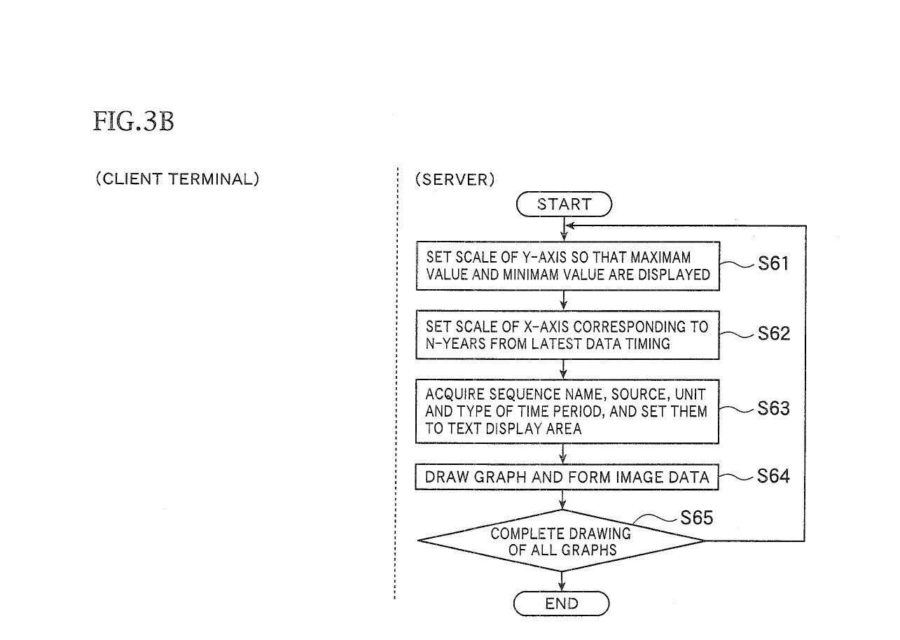

FIG. 3 to 5 are flowcharts showing procedures of the statistical economic data display system of the present embodiment. The processing of the statistical economic data display system is described with reference to these flowcharts hereinafter.

### <Acquisition of the Statistical Economic Data and Display of the Text Information>

The procedures how the statistical economic data is acquired and the text information is displayed are described hereinafter.

First, the user of the client terminal 1a makes the display device 13 to display the web browser 19, accesses the server 2a, and makes the web browser 19 to display the search picture.

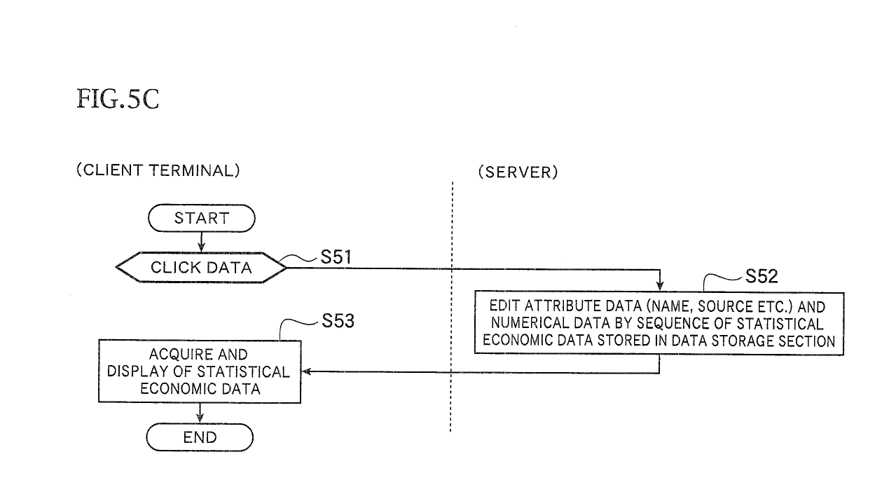

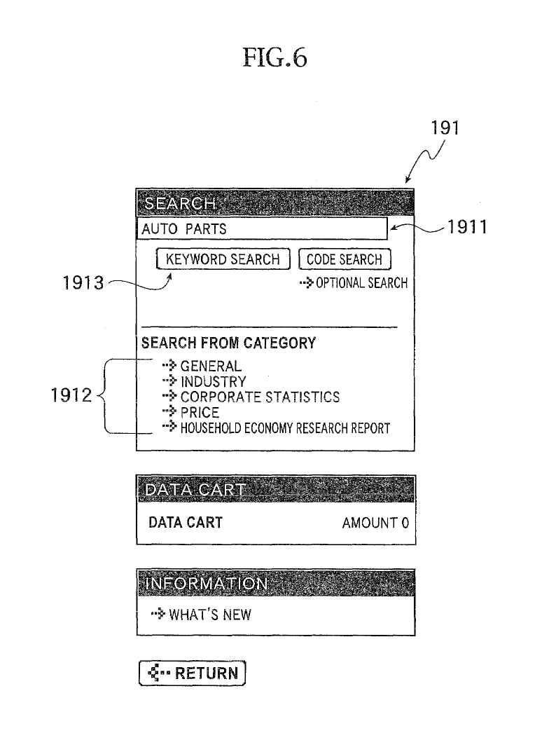

FIG. 6 shows a conceptual diagram of the search picture. As shown in FIG. 6, the search picture 191 has a free word input field 1911. Furthermore, the search picture 191 has a category selection field 1912 used for performing searches based on categories. The present embodiment is described as a case that the free word input field 1911 is used.

The user inputs the free word of text format to the search picture 191, by using the operation device 12 (that is keyboard in this case). FIG. 6 shows a situation that two words of text format, that is ‘auto’ and ‘parts’, have been input to the free word input field 1911 as free words. Under such situation, a free word searching is requested (step S1) when a search execution button 1913 is clicked by the operation device 12 (that is mouse in this case). The data acquisition portion 16 sends the words, which have been input to the free word input field 1911, to the server 2a as a ‘data acquisition command’.

When the server 2a acquires information about the free word searching sent from the data acquisition portion 16, a search for the search targets is performed (step S2). In this case, the search targets are the sequences of the statistical economic data 51, in which the above described free words, that is ‘auto’ and ‘parts’, are contained. In other words, the database server 5 searches the sequences (for example, L (L>1) sequences) of the statistical economic data 51 which contains the above described free words, that is ‘auto’ and ‘parts’, in its attribute data 51a of the plural statistical economic data 51₁, 51₂, . . . , 51ₙ stored (especially attribute information, such as ‘name of sequence’ and ‘source’).

The statistical economic data being extracted by the search is sent to the web server 4a. The data edit portion 411 of the web server 4a firstly acquires the attribute data 51a of the extracted statistical economic data 51 (step S3). Next, the scale setting portion 4132 acquires the numerical data 51b belonging to a predetermined time period as a candidacy group, from each of the sequences in the extracted statistical economic data 51 (step S4). The scale setting portion 4132 of the present embodiment adopts ‘the predetermined time length from the latest specific timing’ as the definition of ‘the predetermined time period’, adopts ‘February, A.D. 2000’ as the definition of ‘the latest specific timing’, and adopts ‘within five years from the specific timing’ as the definition of ‘the predetermined time length’. In other words, the scale setting portion 4132 acquires the numerical data 51b from February, A.D. 2001 to February, A.D. 2006 as the ‘candidacy group’. It becomes possible to make the most valuable graphs for the users by acquiring the numerical data 51b belonging to the predetermined time length from the latest specific timing.

Incidentally, in the case where the numerical data 51b corresponding to a part of the timings belonging to the ‘predetermined time period’ does not exist, only the existing numerical data 51b are acquired as the ‘candidacy group’. For example, in the case where only the numerical data 51b from February, A.D. 2000 to December, A.D. 2005 exist, the scale setting portion 4132 acquires the numerical data 51b from February, A.D. 2001 to December, A.D. 2005 as the candidacy group.

The data edit portion 411 acquires a latest timing of the numerical 51b being acquired as the ‘candidacy group’ (step S5). In the present invention, the numerical data 51b nearest to February, A.D. 2006 that is the ‘latest specific timing’ is acquired.

Moreover, the graph drawing portion 413 performs the drawing of graph and generation of image data (step S6) based on the attribute data 51a and the numerical data 51b acquired by the data edit portion 411. Concretely, the procedures described below and shown in FIG. 3B are executed.

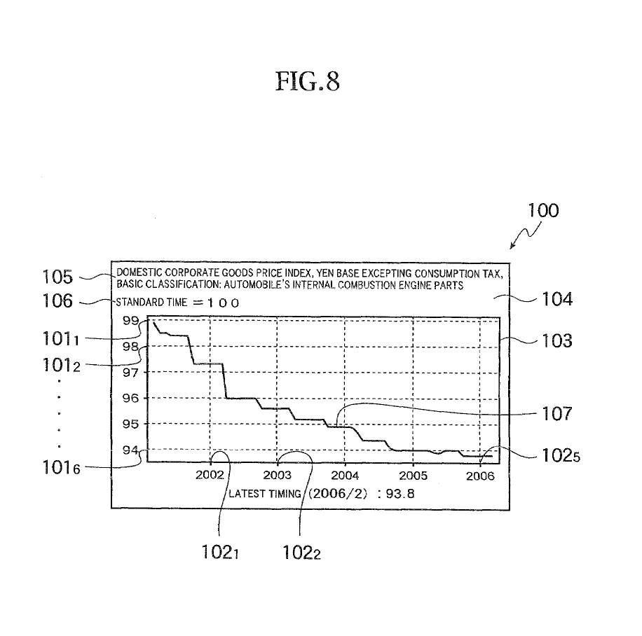

Firstly, the graph drawing portion 413 acquires one sequence from plural sequences in the acquired statistical economic data 51, as an object of graph creation. The scale setting portion 4132 sets a dimension of the Y-axis and adds scales on the Y-axis (step S61). Concretely, the graph drawing portion 413 acquires the maximum value and the minimum value from all of the numerical data 51b₁, 51b₂, . . . , 51bₘ belonging to the statistical economic data 51 acquired at step S4 as the object of graph generation. Additionally the graph drawing portion 413 performs a dimension setting and a scale setting so that the maximum value and the minimum value of graph are equal to the maximum value and the minimum value of the Y-axis. As a result, the dimension is set so that the maximum value (i.e. 98.9) and the minimum value (i.e. 93.8) in the numerical data 51b from February, A.D. 2001 to February, A.D. 2006 are possible to be displayed in the region corresponding to the Y-axis, as shown in the conceptual diagram of FIG. 8, additionally six scales 101₁, 101₂, . . . , 101₆, the coordinate values of which are 99, 98, . . . , 95 and 94, are added.

The scale setting portion 4132 sets a dimension of the X-axis and sets scales of the X-axis (step S62). Concretely the dimension of the X-axis is set so that the time period from February A.D. 2001 to February A.D. 2006, that is ‘the predetermined time period from the latest specific timing’, is possible to be displayed. As a result, five scales 102₁, 102₂, . . . , 102₅ which corresponds to A.D. 2002, 2003, . . . , 2006 are set.

In the case where plural graphs are displayed on the web browser 19 of the client terminal 1a, it is possible to visually compare these plural graphs, because the scale setting portion 4132 generates graphs in which dimensions of the X-axis and the Y-axis are adjusted.

The image formation portion 4131 acquires ‘name of sequence’, ‘source’, ‘unit’, ‘type of time period’ and/or other data from the attribute data 51a contained in the statistical economic data 51 for generating the graph, and displays their data on the predetermined position in a text-display area (step S63). As a result, as described in the conceptual diagram of FIG. 8, the alphanumeric characters of ‘DOMESTIC CORPORATE GOODS PRICE INDEX . . . ’ as a name of sequence 105, the alphanumeric characters of ‘standard time=100’ (which means that the values of graph 107 displayed on the plot area 103 are relative values when the value of A.D. 2000, that is standard time, is defined as 100) as a unit 106 and the alphanumeric characters of ‘latest timing (February, 2006)’ (which means that the latest timing, which belongs to the timings acquired at step S5, displayed on the plot area 103 is February, A.D. 2006) as a latest timing are displayed at a predetermined position in the text-display area 104 of the image data 100. The text-display area 104 may display ‘type of time period’, ‘maximum value’, ‘minimum value’, ‘source’ or other terms constituting the attribute data 51a.

The image formation portion 4131 forms a graph 107 based on all numerical data 51b₁, 51b₂, . . . , 51bₘ contained in the statistical economic data 51 used for the formation of the graph. As a result, image data 100 corresponding to the state that the graph 107 is drawn on the plot area 103 is formed, as shown in the conceptual diagram of FIG. 8.

The process from the step S61 to the step S64 are performed until the processes of the statistical economic data 51 related to all sequences (step S65) are completed. In other words, the number of the formed image data 100₁, 100₂, . . . , 100_{L} is same as the number of the sequences being extracted in the process of step S2. All scales of the X-axis direction in the graphs 107₁, 107₂, . . . , 107_{L} corresponding to these image data 100₁, 100₂, . . . , 100_{L} are united to the ‘specific scale’ described above. Incidentally, each of the image data 100₁, 100₂, . . . , 100_{L} have the same structure, and each of the graph 107₁, 107₂, . . . , 107_{L} have the same structure. Therefore, the image data 100₁, 100₂, . . . , 100_{L} are described as image data 100 and the graph 107₁, 107₂, . . . , 107_{L} are described as graph 107 hereinafter, except for the case distinction is necessary.

Next, the data edit portion 411 edits these statistical economic data 51 to the edited statistical economic data that are not shown in diagrams (step S7). The edited statistical economic data are the data formed by editing all of the statistical economic data extracted in the search process of the step S2 to the HTML format data that can be sent to the client terminal 1a through the Internet 3. The ‘code’ contained in the attributed data 51a is added to the extracted statistical economic data 51 as an ID (i.e. identifier) of each sequence. The image data 100 are put into the HTML format data as the state of non-display.

Next, the edited statistical economic data edited by the data edit portion 411 are sent from the web server 4a to the client terminal la as formats of packets. The client terminal 1a can display the statistical economic data as graphs 107 that are easy to recognize visually and text data of which the summaries are easy to recognize, because the edited statistical economic data are sent to the client terminal 1a (step S8). Moreover, an increase in the communication frequency can be suppressed by acquiring several statistical economic data 51 based on single data acquisition request.

The command generation portion 412 converts commands for formation, commands for action and so forth to HTML documents, and sends the document to client terminal 1a. Consequently, the users of the client terminal 1a can use the statistical economic data display system without booting the ‘predetermined composition element’ which is, for example, the data acquisition portion 16, the text information generation portion 17 or the graph display portion 18, and without inputting a command for action.

In the client terminal 1a, the data acquisition portion 16 acquires the edited statistical economic data and generates the text information generation portion 17 and the graph display portion 18 (in which the display area formation portion 181 and the image display portion 182 are contained). The attribute information 51a in the acquired edited statistical economic data is sent to the text information generation portion 17, and the text information generation portion 17 generates visual information of the text based on the attribute information 51a. The text information generated by the text information generation portion 17 is displayed on the web browser 19 as text information displaying pictures (step S6).

Incidentally, all of the edited statistical economic data acquired by the data acquisition portion 16 are stored into the data memory section 141. As a result, the image data 100 corresponding to the non-displayed text data and the non-displayed graphs 107 can be displayed immediately on the display means.

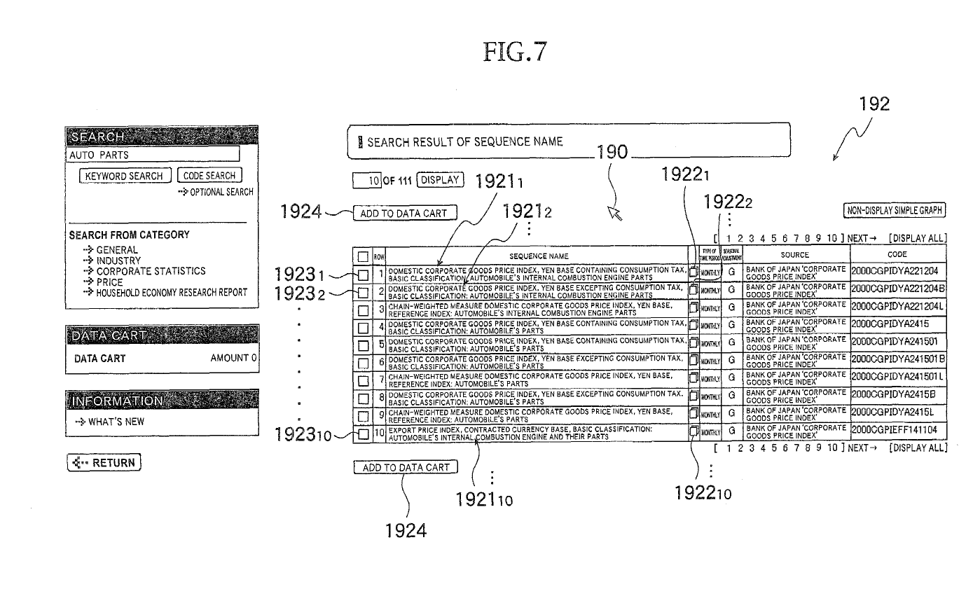

FIG. 7 shows a conceptual diagram of a text information display picture. As shown in FIG. 7, the sequence names 1921₁, 1921₂, . . . , 1921₁₀ of plural sequences (ten sequences in this case), are enumerated on the text information display picture 192, as ‘text information’. As described above, the data of ‘name’ contained in the attribute information are formed as text information. Incidentally, the display device 13 displays the non-displayed attribute data 51a, which are contained in the edited statistical economic data acquired by the data acquisition portion 116, on the text information display picture 192, when the request button for displaying other information (not shown in FIG. 7) is clicked.

### <Displaying of Graphs>

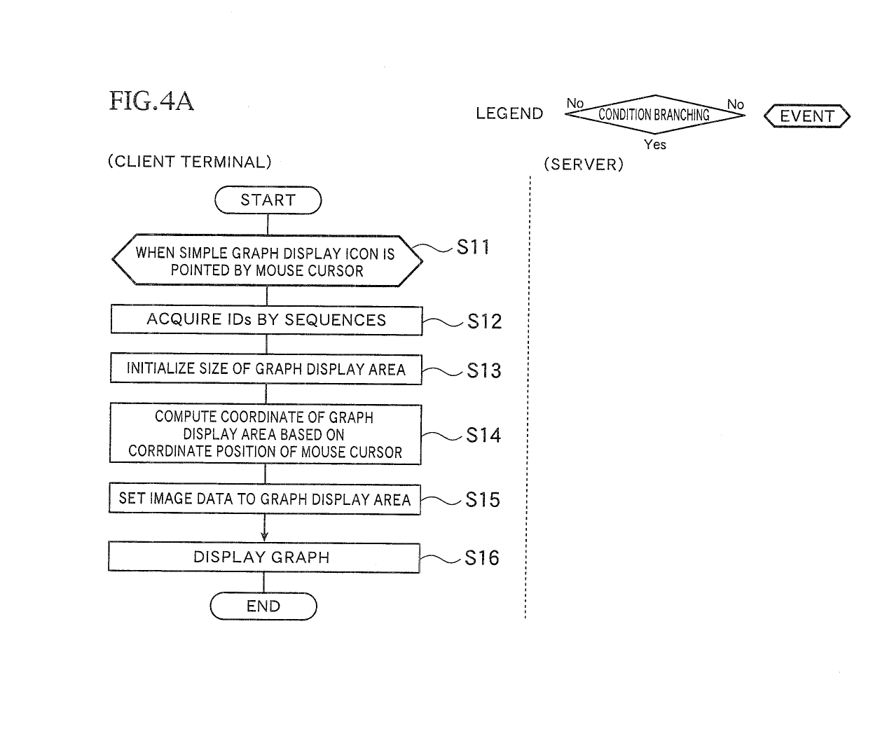

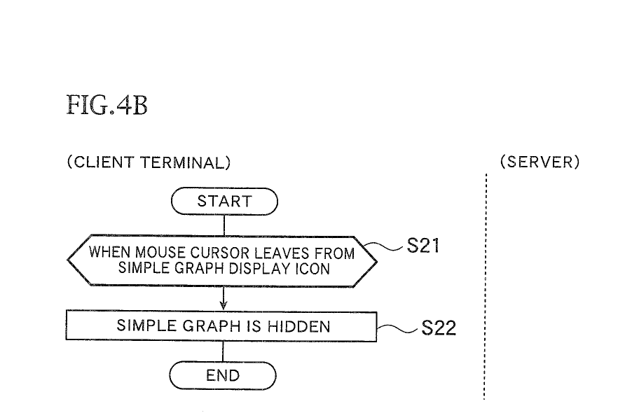

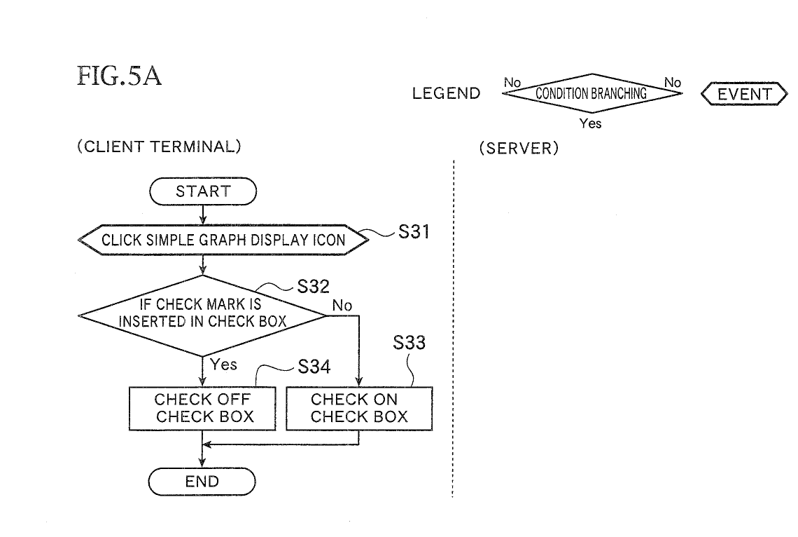

Hereinafter, the displaying procedures are described with reference to the flowchart shown in FIG. 4A.

The text information display picture 192 displays the graph-display icons 1922₁, 1922₂, . . . , 1922₁₀, the number of which is same as the number of sequence name 1921₁, 1921₂, . . . , 1921₁₀. The graph-display icons 1922₁, 1922₂, . . . , 1922₁₀ are displayed next to the enumerated sequence name 1921₁, 1921₂, . . . , 1921₁₀. When the tip of a mouse cursor 190 is positioned on the specific graph-display icon, for example the graph-display icon 1922₁, the numerical data 51b, which is contained in the statistical economic data corresponding to the sequence name 1921₁ next to the graph-display icon 1922₂ pointed by the tip of a mouse cursor 190, are displayed on the web browser 19 as the graph 107. Hereinafter, actual procedures for the displaying are described.

When the mouse cursor 190, that is ‘pointing device’, is positioned on the graph-display icon 1922₂ shown in FIG. 7 (step S11), the ‘data acquisition request’ is generated. The graph display portion 18 acquires the ID numbers corresponding to each of the sequence number name 1921₂ next to the graph-display icon 1922₂ pointed by the mouse cursor 190 based on the data acquisition request (step S12), and acquires the image data 100 corresponding to the acquired ID number from the edited statistical economic data stored in the data memory section 141.

Incidentally, the display area formation portion 181 initializes the size setting of the graph-display area (step S13) and computes the size of the graph-display area. The graph-display area is set to the same size at all times, unless there is an especial command for changing sizes from the clients or the program stored in the memory device 42.

Furthermore, the display area formation portion 181 computes the coordinates of the graph-display area based on the coordinates position pointed by the mouse cursor 190 (step S14). In the present embodiment, the displayed position of the graph-display area is computed so that the top of the left side of the graph-display area is located on the bottom of right side of the graph-display icon 1922₂ pointed by the mouse cursor 190.

The image display portion 182 executes the settings tor displaying the image data 100 corresponding to the graph 107 generated based on the numerical data 51b contained in the statistical economic data 51 of the acquired sequence (step S15). In the present embodiment, the setting is executed so that the image data 100 is displayed on the whole region of the graph-display area.

The display area formation portion 181 makes the graph-display area of image data 100 to be displayed on the web browser 19 as a pop up picture.

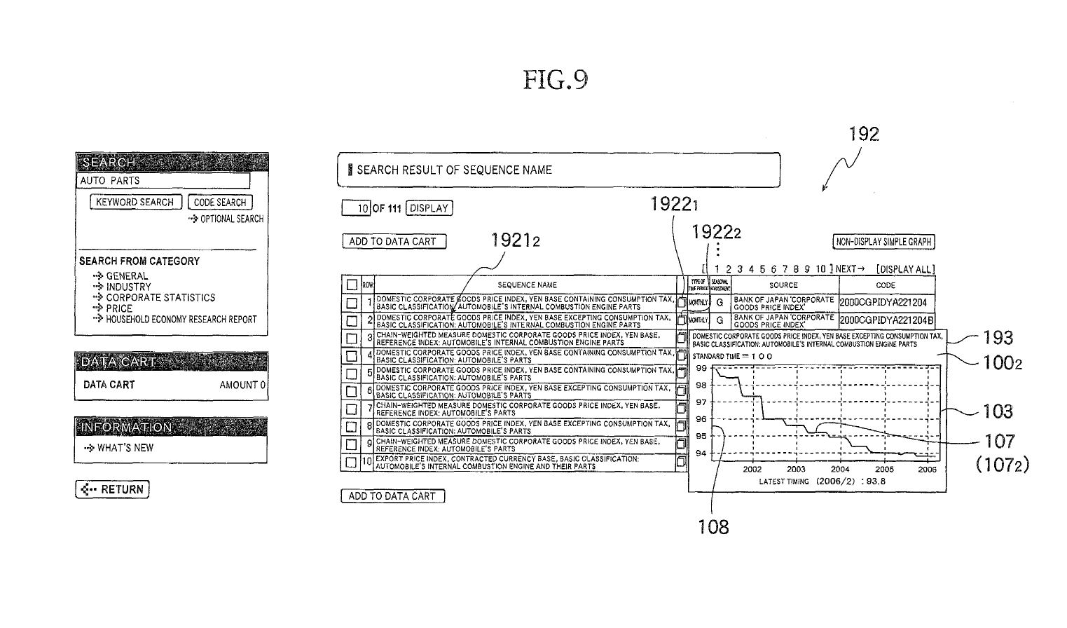

FIG. 9 is a conceptual diagram of the graph-display area that is displayed on the web browser 19. The graph-display area 193 of FIG. 9 is displayed on the text information displaying picture 192 as a pop up picture, and the image data 100₂ corresponding to the graph display icon 1922₂ is displayed on the whole region of the graph-display area 193.

As described above, the present embodiment stores the edited statistical economic data acquired by the data acquisition portion 16 in advance. In addition, the present embodiment specifies the sequence name 1921₂ corresponding to the graph-display icon 1922₂, by pointing out using the mouse cursor 190, from the sequence names displayed on the text information display picture 192. Furthermore, the present embodiment acquires the image data 100₂ for displaying the graph 107₂ of the numerical data 51b, corresponding to the specified sequence name 1921₂, from the data memory section 141. Moreover, the present embodiment displays the image data 100₂ on the web browser 19, as a pop up picture. Consequently, the non-displayed graph 107, which is acquired based on the ‘data acquisition command’ corresponding to the request of step S1, can be displayed on the web browser 19 immediately, without sending the data acquisition request to the server 2a. As a result, an increase in the data quantity of the statistical economic data 51 stored in the data memory section 141 can be suppressed, an increase in the communication frequency between the client terminal 1a and the web server 4a can be suppressed, while a response time for displaying the necessary numerical data 51b on the web browser 19 as the graph 107 can be reduced.

Moreover, the present embodiment can adjust the number of data item displayed on the text information display picture 192 at the same time so as to easy to view, because the present embodiment specifies the sequence name 1921₂ corresponding to the graph-display icon 1922₂, which is pointed out by the mouse cursor 190, from the sequence names displayed on the text information display picture 192, acquires the image data 100₁, 100₂, . . . , 100₁₀ for displaying the graph 107₁, 107₂, . . . , 107₁₀ corresponding to the specific sequence name 1921₂, displays the image data 100₁, 100₂, . . . , 100₁₀ on the graph display area 193, and displays the graph display area 193 on the web browser 19.

Additionally, the present embodiment can display the graph 107 while the sequence name 1921₁, 1921₂, . . . , 1921₁₀ are displayed, because the present embodiment displays the graph display area 193 as a pop up picture on the text information display picture 192 displaying the sequence name 1921₁, 1921₂, . . . , 1921₁₀.

Furthermore, the present embodiment can display the numerical data 51b on the web browser 19 so as to easy to view, because the numerical data 51b is displayed on the graph display area 193 as graph 107 by the graph drawing portion 413.

### <Erasing of Graphs>

Hereinafter, the procedures for erasing displayed graphs are described with reference to the flowchart shown in FIG. 6B.

In the case where the graph display area 193 is displayed on the web browser 19 and the image data 100₂ is displayed on the graph display area 193, the display area formation portion 181 erases the graph display area 193 from the web browser 19, when the mouse cursor 190 leaves from the position on the graph display icon 1922₂ (step S21), and so the graph display area 193 shown in FIG. 9 is hidden (step S22). As a result, the image data 100₂ corresponding to the graph 107₂, of which the user of the client terminal 1a does not want to display, can be erased from the picture on the web browser 19 immediately.

### <Consecutive Displaying of Plural Graphs>

Incidentally, the present embodiment can display and erase the image data 100₁, 100₂, . . . , 100₁₀ for displaying the graph 107₁, 107₂, . . . , 107₁₀ corresponding to the sequence name 1921₁, 1921₂, . . . , 1921₁₀ immediately and consecutively by quickly moving the mouse cursor 190 to upper direction or lower direction, because the procedures of steps S11 through S18 and steps S21 through S22 are executed consecutively. The present embodiment can execute consecutive displaying and erasing of the image data 100₁, 100₂, . . . , 100₁₀ easily and immediately by only moving the mouse cursor 190 to the vertical direction, because the graph display icons 1922₁, 1922₂, . . . , 1922₁₀ are arranged along single vertical line.

For example, when the mouse cursor 190 under the situation shown in FIG. 9 leaves from the position on the graph display icon 1922₂ and moves to point out the graph display icon 1922₄, the graph display area 193, on the whole area of which the image data 100₄ corresponding to the graph 107₄ of the sequence 1921₄ is drawn, is displayed as a pop up picture, instead of the graph display area 193, on the whole area of which the image data 100₂ corresponding to the graph 107₂ of the sequence 1921₂ is drawn. Similarly, when the mouse cursor 190 moves to point out the graph display icons 1922₅, 1922₆, . . . , 1922₁₀, the graph display area 193, on the whole area of which the image data 100₅, 100₆, . . . , 100₁₀ (not shown in FIG. 9) corresponding to the graph 107₅, 107₆, . . . , 107₁₀ (not shown in FIG. 9) of the sequence 1921₅, 1921₆, . . . , 1921₁₀ (not shown in FIG. 9) are drawn, are displayed as pop up pictures.

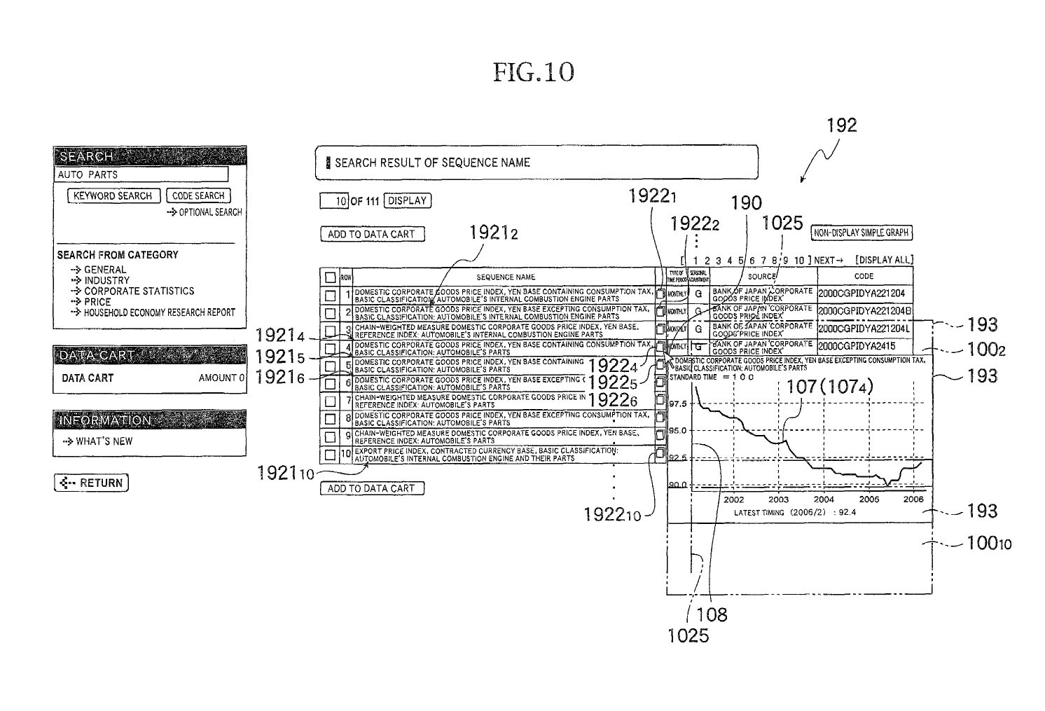

Incidentally, all of the graphs 107₁, 107₂, . . . , 107₁₀ corresponding to the image data 100₁, 100₂, . . . , 100₁₀ displayed on the web browser 19 have the X-axis in which the scale of them are always the same, because the X-directions of the graphs 107₁, 107₂, . . . , 107₁₀ (partly shown in FIG. 9, it is similar as follows) of the image data 100₁, 100₂, . . . , 100₁₀ are unified to have the same scale. The scale of the X-axis corresponds to the time period from October, A.D. 2001 to October, A.D. 2006, that is ‘the predetermined time period from the latest specific timing’, and the sizes of the graph display area 193, 193, . . . , 193 are set to the same sizes. Consequently, as shown in FIG. 10, the Y-axis 108 of the graphs 107 are always positioned on the same virtual vertical lines 1025, and the horizontal positions of the five scales 102₁, 102₂, . . . , 102₅ are always the same.

Therefore, the present embodiment can visually compare plural graphs 107₁, 107₂, . . . , 107₁₀ easily by making the plural graph display area 193, 193, . . . , 193 to be displayed and erased consecutively.

Moreover, the present embodiment can compare plural graphs 107₁, 107₂, . . . , 107₁₀ easily in the case where the scales of the Y-axis are different from each other, as shown in FIGS. 9 and 10, in addition to the case where the scales of the Y-axis are the same.

Furthermore, all of the graphs 107₁, 107₂, . . . , 107₁₀ of the image data 100₁, 100₂, . . . , 100₁₀ are displayed on the web browser 19 so that the positions of the horizontal direction are the same. Consequently, the time information, which is X-axis's information of the graph of the statistical economic data 51, are unified as one position information of the web browser 19, and so the graphs 107₁, 107₂, . . . , 1071₁₀ of the plural image data 100₁, 100₂, . . . , 100₁₀ can be easily compared as visual data.

Additionally, the slopes of lines of the graphs 107 become substantially sharp and the tendency of the variation of the Y-axis direction becomes clear because the maximum value and the minimum value of the graphs 107 of the image data 100 are set to be nearly the same as the maximum value and the minimum value of the Y-axis 108, and so the summaries of the graphs in the image data 100 become easy to grasp, even if the displaying time of pop up image data is short.

### <Acquisition of Specific Statistical Economic Data>

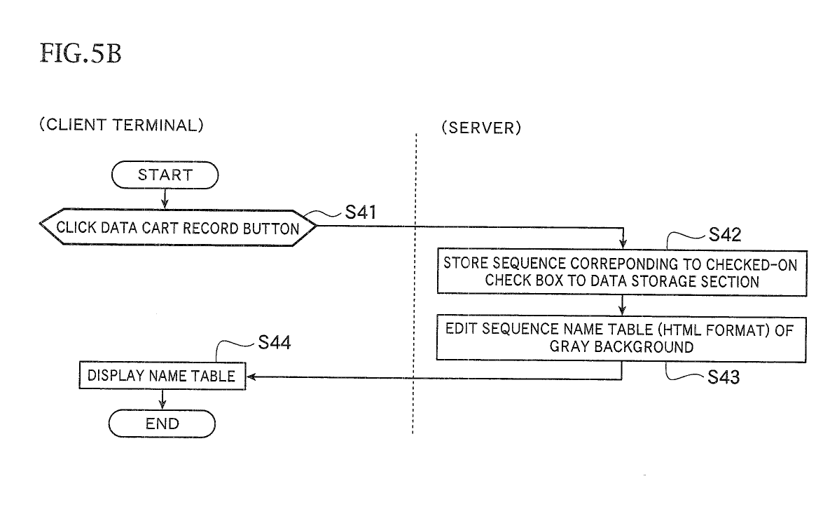

Hereinafter, the procedures for acquiring a specific statistical economic data are disclosed with reference to the flowcharts shown in FIGS. 5A to 5C.

FIG. 5A is a flowchart showing the procedures of selecting the specific statistical economic data that is requested to be acquired. As shown in FIG. 7, the text information display picture 192 on the web browser 19 displays the check boxes 1923₁, 1923₂, . . . , 1923₁₀, the number of which is same as the number of the sequence names 1921₁, 1921₂, . . . , 1921₁₀ and which are arranged near the enumerated sequence names 1921₁, 1921₂, . . . , 1921₁₀, along a vertical line. These check boxes 1923₁, 1923₂, . . . , 1923₁₀ are used when the storing of the statistical economic data 51 into the ‘data storage section’ described below is requested. When the specific graph display icon, for example the graph display icon 1922₂, is clicked by the mouse cursor 190 (step S31), the data acquisition portion 16 inserts the check mark in the check box 1923₂ (step S33) in the case where the check box 1923₂ arranged in the same row as the clicked graph display icon 1922₂ is not checked on (“No” of step S32), and the data acquisition portion 16 deletes the check mark from the check box 1923₂ (step S34) in the case where the check box 1923₂ arranged in the same row as the clicked graph display icon 1922₂ is checked on (“Yes” of step S32).

FIG. 5B is a flowchart showing the procedures of displaying the sequence name of the selected specific statistical economic data 51 on the web browser 19. As shown in FIG. 7, a data cart record button 1924 is displayed in the text information display picture 192 on the web browser 19. Incidentally, the ‘data cart’ is a memory area for temporarily storing specific statistical economic data 51. In the present embodiment, the ‘data cart’ corresponds to the data storage section 421 in the web server 4a.

The data acquisition portion 16 sends the information of the sequence name 1921₂ adjoining the check box 1923₂ being checked, which is the ID number of the statistical economic data 51 containing the sequence name 1921₂, to the server 2a, when the data cart record button 1924 is clicked by the mouse cursor 190 (step S41). The server 2a requests an acquisition of the statistical economic data 51 which contains the sequence name 1921₂. The server 2a acquires the requested statistical economic data 51 based on the acquisition request from the database server 5, and stores the acquired statistical economic data 51 to the data storage section 421 (step S42). The data edit portion 411 edits a sequence name table data of HTML format, which contains the sequence names corresponding to the statistical economic data stored in the data storage section 421 (step S43). The sequence name table contains the sequence names displayed in the text information display picture 192 on the web browser 19 of the client terminal 1a at that time, and the column of the sequence names corresponding to the statistical economic data stored in the data storage section 421 has different background color (that is gray in the present embodiment) from those of other sequence names. The data edit portion 411 sends the sequence name table data to the client terminal 1a. The data acquisition portion 16 forms a name table picture based on the sequence name table data and displays it on the web browser 19 (Step S44).

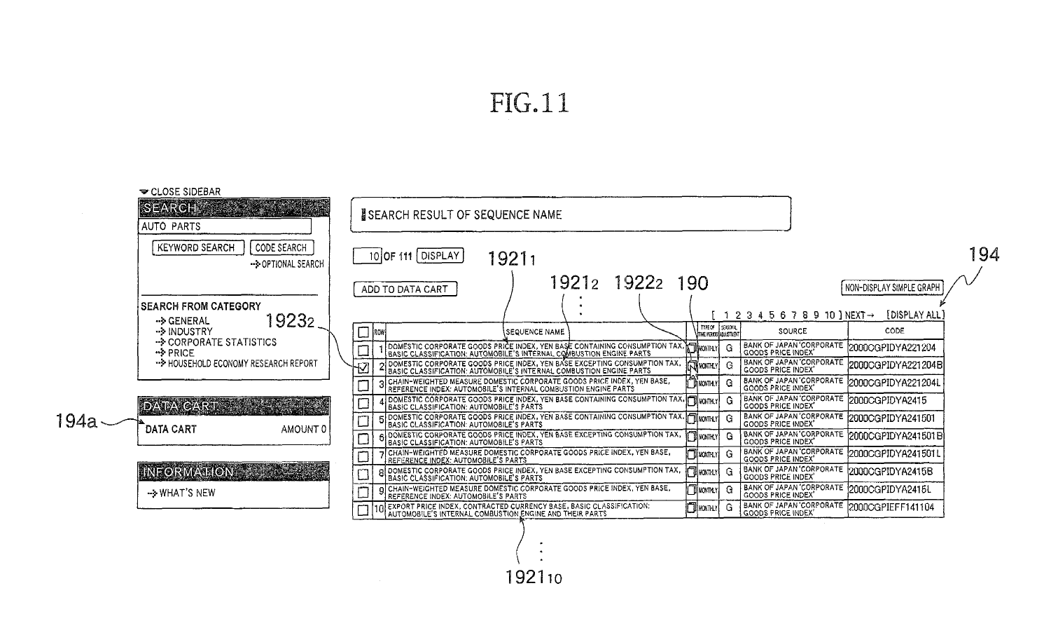

FIG. 1 shows a conceptual diagram of a name table picture. As shown in FIG. 11, the sequence names 1921₁, 1921₂, . . . , 1921₁₀ are displayed similar to the text information display picture 192, and the sequence name 1921₂ corresponding to the statistical economic data 51 stored in the data storage section 421 is marked by the gray background. Consequently, the user of the client terminal 1a can easily recognize the sequence name of the statistical economic data 51 stored in the data storage section 421.

FIG. 5C is a flowchart showing the procedures for downloading selected specific statistical economic data 51 to the client terminal 1a.

The data acquisition portion 16 requests the acquisition of the statistical economic data 51 stored in the data storage section 421 to the server 2a, when the stored data acquisition button 194a is clicked (step S51). The web server 4a of the server 2a extracts the statistical economic data 51 from the data storage section 421 based on the request, and the data edit portion 411 edits the attribution data 51a. Moreover, the web server 4a of the server 2a edits the numerical data 51b of the acquired statistical economic data 51 to a spreadsheet format (step S52), and sends it to the client terminal 1a. The data acquisition portion 16 of the client terminal 1a makes spreadsheet software, for example EXCEL (trademark), to input the acquired statistical economic data 51, and makes the display device 13 to display them as formats of graphs and/or tables (step S53). As a result, the users of the client terminal 1a can acquire their especially desired numerical data 51b from the numerical data 5b displayed as the sequence names 1921₁, 1921₂, . . . , 1921₁₀ and graphs 107₁, 107₂, . . . , 107₁₀ on the text information display picture 192. Furthermore, the users of the client terminal 1a can study the acquired statistical economic data 51 in detail by forming detailed graphs or tables using spreadsheet software, for example.

As described above, the present embodiment can display the statistical economic data 51 of a state easily to view, can prevent increase of communication frequency between the client terminal 1a and the web server 4a, and can shorten the response time for displaying the necessary data, even the screen size of the display device 13 in the client terminal 1a is small and/or the capacity of the memory device is small. Additionally, the user can view their desired graphs 107₁, 107₂, . . . , 107₁₀, which corresponds to plural image data 100₁, 100₂, . . . , 100₁₀, under the state comparison is possible. As a result, high usability can be realized.

The present embodiment described above has a composition that the graph-display icons 1922₁, 1922₂, . . . , 1922₁₀ are displayed next to the sequence names 1921₁, 1921₂, . . . , 1921₁₀ on the text information display picture 192, however a composition that the functions same as the graph-display icons 1922₁, 1922₂, . . . , 1922₁₀ are added to the sequence names 1921₁, 1921₂, . . . , 1921₁₀ and the graph-display icons 1922₁, 1922₂, . . . , 1922₁₀ are not displayed, is possible. In the case where such composition is adopted, a graph display area 193 is displayed as a pop up picture when the mouse cursor 190 is positioned on the specific sequence name (for example, the sequence name 1921₂), the graph display picture area 193 displays the graph 107₂ related to the corresponding sequence name 1921₂. By adopting such composition, the structure of the text information display picture 192 can be simpler and the picture of the text information display picture 192 can be easier to view.

### Second Embodiment of the Present Invention

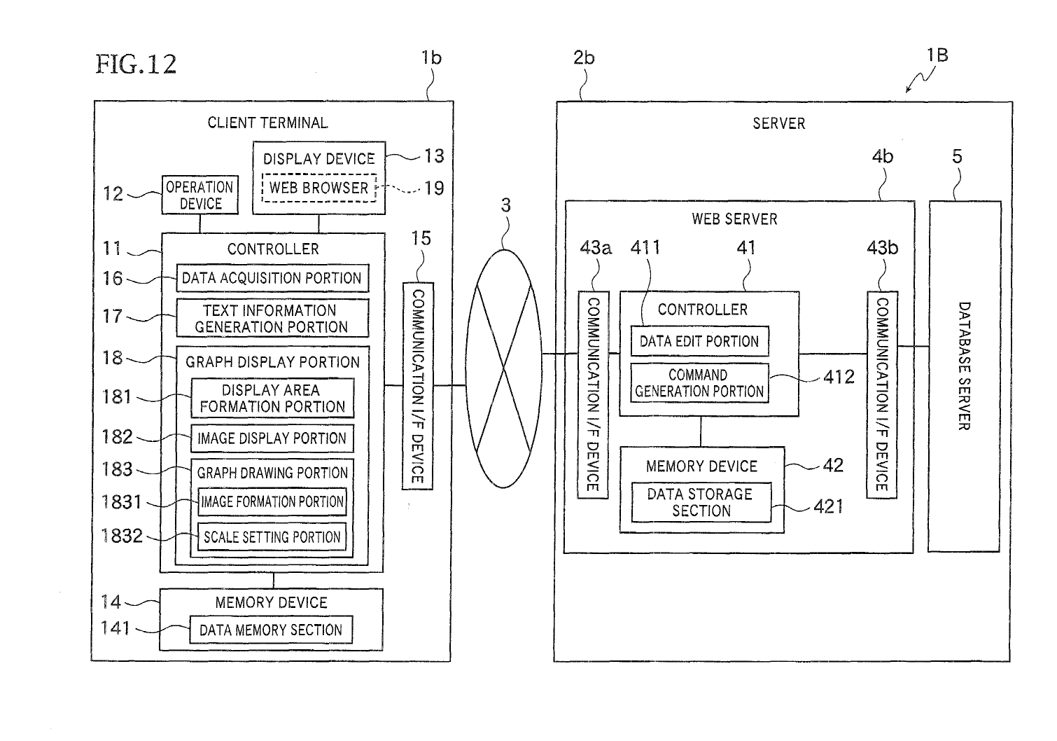

FIG. 12 shows the second embodiment of the present invention.

As shown in FIG. 12, the client terminal 1b and the server 2b are connected to the Internet 3, and the server 2b has the web server 4b and database server 5 in the statistical economic data display system 1B of the present embodiment. In the present embodiment, the graph drawing portion 183 is mounted in the client terminal 1b, differing from the first embodiment where the graph drawing portion 413 was mounted in the server 4a. The composition and function of the graph drawing portion 183, the image formation portion 1831 and scale setting portion 1832 are same as the graph drawing portion 413, the image formation portion 4131 and scale setting portion 4132 of the first embodiment, however the composition and function of the graph drawing portion 183, the image formation portion 1831 and scale setting portion 1832 are realized by programs using image description languages of client side, for example, VML (Vector Markup Language), SVG (Scalable Vector Graphics) or other languages. The drawn graphs are formed to the image information. Incidentally, the graph drawing portion 183 is constructed based on the construction command from the command generation portion 412 and activate based on the action command from the command generation portion 412, similar to the data acquisition portion 16 and the text information formation portion 17.

The data edit portion 411 of the present embodiment generates the statistical economic data, instead of the edited statistical economic data. In other words, the present embodiment inputs the numerical data 51b of non-display format to HTML, instead of the image data 100 of the step S7 in the first embodiment. In addition, the present embodiment performs the process corresponding to the step S6 (and the processes of step S61 through S65) of the first embodiment in the procedures for displaying the image data 100 in the client terminal 1b (for example, as a process between the step S14 and step S15 in FIG. 4).

Except for the above described processes, the second embodiment is substantially the same as the first embodiment.

The present embodiment has a technical advantage, comparing with the first embodiment, that can reduce the load related to processing of server 2b, in addition to the same technical advantage as the first embodiment, because the processes for drawing the graph are performed in the graph drawing portion 183 mounted in the side of the client terminal 1b.

In each of the embodiments described above, a plurality of the statistical economic data 51 corresponding to one acquisition command are send from the web servers 4a, 4b to the client terminals 1a, 1b at once, however, the statistical economic data 51 can be send by using an asynchronous communication system for Ajax (Asynchronous JavaScript+XML). Consequently, the data transmissions from the web servers 4a, 4b to the client terminals 1a, 1b parallel with the operations of users and the drawings of the screen become possible. In other words, the client terminals 1a and 1b can be operated by the users and can perform the drawing processes of pictures while the web servers 4a, 4b and the client terminals 1a, 1b communicate mutually. As a result, high usability for the user of the client terminals 1a and 1b can be improved.

In each of the embodiments described above, a client and server type computer system is adopted as the statistical economic data display systems 1A and 1B. However, a standalone type computer system can be adopted as the statistical economic data display systems 1A and 1B.

It is obvious that every embodiments described above are merely examples, and the present invention is not limited to these embodiments.

### DESCRIPTION OF REFERENCE SYMBOLS

1A, 1B: statistical economic data display system
1a, 1b: client terminal
2a, 2b: server
13: display device (display means)
16: data acquisition portion (data acquisition means)
141: data memory device (data memory means)
17: text information generation portion (text information generation means)
18: graph display portion (graph display means)
51, 51₁, 51₂, . . . , 51ₙ: statistical economic data
51b: numerical data
100: image data
107, 107₁, 107₂, . . . , 107₁₀: graph (numerical information)
181: display area formation portion (display area formation means)
190: mouse cursor (pointing device)
1921₁, 1921₂, . . . , 1921₁₀, 105: sequence name (text information)
193: graph display area (numerical information display area)
413, 183: graph drawing portion (graph drawing means)
4132: scale setting portion (scale setting means)

1-7. (canceled)

8. A statistical data display system comprising;
a database which stores plural kinds of statistical data containing attribute data and numerical data,
a search portion which searches the statistical data by comparing one or more search terms specified by an operator and the attribute data contained in the statistical data,
a graph drawing portion which generates a simple graph using a part of the numerical data contained in the statistical data corresponding to the search result of the search portion when the search portion performs the search, and generates a detailed graph using all of the numerical data contained in the requested statistical data when the operator requests one or more of the statistical data corresponding to the search result of the search portion, and
a graph display portion which acquires the simple graph and the detailed graph, and makes a display device to display the simple graph and the detailed graph.

9. The statistical data display system according to claim 8, wherein;
the graph display portion makes the display device to display an information table for distinguishing the statistical data corresponding to the search result, and
the graph display portion acquires the simple graph and makes the display device to display the simple graph, when one or more of the statistical data of the information table is requested by the operator.

10. The statistical data display system according to claim 9, wherein the graph display portion makes the display device to display the simple graph as a pop up picture, when the operator specifies one of the statistical data of the information table by using a pointer displayed on the display device.

11. The statistical data display system according to claim 10, wherein the graph display portion makes the display device to terminate the displaying of the pop up picture of the simple graph, when the operator releases the designation of the statistical data by dislocating the display position of the pointer.

12. The statistical data display system according to claim 8, wherein the graph display portion makes the display device to display an operation button image for the operator to select the requested statistical data, from the statistical data corresponding to the search result.

13. The statistical data display system according to claim 12, wherein the graph display portion makes the display device to display an operation button image to display an information table for distinguishing the statistical data selected by the operator.

14. The statistical data display system according to claim 12, wherein the graph display portion makes the display device to display an operation button image for making the statistical data selected by the operator to be requested all together.

15. The statistical data display system according to claim 8, comprising a scale setting portion which sets the coordinate axes of the simple graphs so that all of the simple graphs generated by the graph drawing portion have the same size.

16. The statistical data display system according to claim 15, wherein;
one of the axes is a time coordinate axis,
the scale setting portion extracts only the numerical data corresponding to the time coordinates of predetermined time period from the latest time coordinate, and
the graph drawing portion generates the simple graph using only the numerical data extracted by the scale setting portion.

17. The statistical data display system according to claim 16, wherein;
another of the axes is an axis corresponding to the value of the numerical data, and
the scale setting portion sets the axis corresponding to the value of the numerical data so that all of the numerical data extracted by the scale setting portion are displayed in the display area of the simple graph.

18. The statistical data display system according to claim 17, wherein;
the scale setting portion extracts a maximum value and a minimum value among all of the numerical data extracted by the scale setting portion, and
the scale setting portion sets the axis corresponding to the value of the numerical data so that the maximum value and the minimum value are displayed in the display area of the simple graph.

19. The statistical data display system according to claim 8, further comprising a data edit portion which converts the data format of the attribute data to a predetermined data format.

20. The statistical data display system according to claim 8, wherein a server comprising at least the database and a client terminal comprising at least the graph display portion are connected through a communication circuit.

21. The statistical data display system according to claim 20, wherein;
the client terminal comprises a data acquisition portion which makes the operator to select one or more of the statistical data corresponding to the search result, and sends a selection information indicating the selected statistical data to the server,
the server comprises a temporarily memory which stores the statistical data corresponding to the selection information when the server receives the selection information, and
the client terminal comprises a data memory which receives and stores the statistical data stored in the temporarily memory all together, when the selected statistical data are requested by the operator.

22. The statistical data display system according to claim 20, wherein the graph drawing portion is located in the server.

23. The statistical data display system according to claim 20, wherein the graph drawing portion is located in the client terminal.

24. The statistical data display system according to claim 8, wherein the graph display portion makes the display device to display an information table of predetermined text contained in the attribute data, for distinguishing the statistical data corresponding to the search result.

25. A computer-readable storage medium storing computer programs that cause the computer to;
input the search result concerning the statistical data containing attribute data for the search and numerical data for generating graph,
generate a simple graph using a part of the numerical data contained in the statistical data corresponding to the search result, and
generate a detailed graph using all of the numerical data contained in the requested statistical data, when an operator requests one or more of the statistical data corresponding to the search result.

26. The computer-readable storage medium according to claim 25, further storing a computer program that causes the computer to perform a process for making a display device to display the simple graph and the detailed graph.

27. The computer-readable storage medium according to claim 25, further storing a computer program that causes the computer to perform a process for making another computer to control a display device to display the simple graph and the detailed graph.
